(19) United States
(12) Patent Application Publication
(10) Pub. No.: US 2023/0142659 A1
(43) Pub. Date: May 11, 2023

(54) SYSTEM AND METHOD FOR REGISTERING SHARE OF ASSET OF WHICH OWNER CANNOT BE SPECIFIED OR OWNERSHIP DOES NOT EXIST

(71) Applicant: Eun Ha SONG, Seoul (KR)

(72) Inventor: Eun Ha SONG, Seoul (KR)

(21) Appl. No.: 17/917,552

(22) PCT Filed: Apr. 7, 2021
(86) PCT No.: PCT/KR2021/004310

§ 371 Date: Oct. 6, 2022

(30) Foreign Application Priority Data
Apr. 7, 2020 (KR) 10-2020-0041942
Nov. 18, 2020 (KR) 10-2020-0154516

(51) Int. Cl. G06Q 50/16

(52) U.S. Cl. CPC G06Q 50/16; G06Q 2220/12

(57) ABSTRACT

The present inventive concept relates to a system and method for registering a share of an asset of which an owner cannot be specified or ownership does not exist, and to a system and method that, for a share of an asset which is an owner-non-specific asset of which an owner cannot be specified or does not exist, allow the public to participate in registration by using a trust system based on blockchain, so that ownership of the share can be objectively recognized by the public.

### TECHNICAL FIELD

The present disclosure relates to a system and method for registering a share of an asset of which an owner cannot be specified or ownership does not exist, and to a blockchain-based public registration system and method that, for a share of an asset which is an owner-non-specific asset of which an owner cannot be specified or does not exist, allow the public to participate in registration by using a trust system based on blockchain, so that ownership of the share can be objectively recognized by the public.

### BACKGROUND ART

It is characterized in that socialist countries usually do not recognize individual private property, but rather place the property under the control of the state, and capitalist countries broadly recognize individual private property. However, even in case of a capitalist country, if the whereabouts for an ownership of an individual private property is unclear, the state has the original ownership.

However, there are some assets on the planet (i.e., the Earth) that are difficult to recognize as the property of a specific country. For example, Antarctica or Arctic or deep-sea is a common heritage of mankind. These are kinds of assets that cannot be owned by a specific country or company. In fact, these are clearly assets that are commonly owned because there is no other alternative to grant ownership to a specific person or a specific country.

As such, when the ownership of an asset is unclear or it is an asset of all mankind, there is no clear plan or countermeasure for how to recognize, register, and manage the ownership. Therefore, it is not appropriate to use an asset for which the owner cannot be specified or for which the ownership does not exist. It is also a historical fact that the great powers around the world used to go to war in order to own an asset that was even considered to be useful.

In fact, since there are very few useless assets on the Earth, countries around the world are fighting a silent war under the surface for the common heritage of mankind. For example, in case of an asset that no one can ostensibly claim sovereignty due to international treaties, but that a specific owner cannot be identified or ownership does not exist and that a repository of mineral and fish stocks has been confirmed, countries around the world are fighting to get even a little more possession. In other words, there is no system of management of ownership for assets that do not have a clear owner or government with ownership.

Some problems can be found herein. On the reason why the state which is the central institution, instead of the citizens of mankind claims ownership of a common heritage of mankind, then on the question that the property of all mankind is no one's property, and on the question whether the central institution (the state) has the right and obligation to distribute the property appropriately to mankind, history, of course, teaches otherwise.

For example, shepherds are trapped in a system that cannot but increase their livestock indefinitely on limited pastures. Everyone is running towards catastrophe, believing that the common land can be freely used by everyone, pursuing only their own interests. Humanity lives on a resource that has the potential of the tragedy of the commons. To avoid this tragedy, privatization or shared ecosystems and appropriate institutions are needed. This is true for parts of the Earth as well as other planets, including the Moon and Mars.

The present inventive concept has been devised to solve these problems and intends to solve the above problems with a system and method for public registration using a blockchain for the share of owner unspecified assets. In the present inventive concept, the owner unspecified common property(asset) includes movable property, real estate, and the like.

The present disclosure relates to a system and method for registering a share in an asset of which owner cannot be specified or ownership does not exist, in more detail, relates to a system and method that enables the public to participate and register by a trust system based on a blockchain so that the ownership can be objectively recognized by the public, for the share of a common asset, which is a non-owner-specific asset, where owner cannot be specified or ownership does not exist.

That is, the present disclosure relates to a system and method for registering a share in an asset in which the owner cannot be specified, or the ownership does not exist, by having the public participate and register through the blockchain for assets in which owner cannot be specified or ownership does not exist, presents a system and method that are not biased by anyone and that rightfully acquire an ownership by being objectively recognized by the public through a trust system by a blockchain.

Hereinafter, the prior art existing in the technical field of the present inventive concept is briefly described, and then the technical matters that the present inventive concept intends to achieve differently from the prior art are described.

First, Korean Patent No. 2065315 (2020 Jan. 13) relates to a blockchain-based file storage and sharing system and method, is characterized in that it is possible to provide a smart notarization service that is impossible to arbitrarily tamper and assure reliable proof and protection of contents by storing all information through hashing (registration) based on a blockchain technology, and a specific third party can inquire a document or file with high reliability and security through a sharing function.

The prior art is characterized in including a blockchain network having a block in which a transaction value generated by combining a hash value of a file and a public key is stored, generating a shared transaction value by using the information of the sharer who wants to share the file, generating a block in which the shared transaction value is stored, and recording the block in the ledger of the blockchain network.

However, the present inventive concept does not refer to registration through the blockchain inherent hashing of the prior art, utilizes a blockchain technology in order to make the share of an asset in which an owner cannot be identified or ownership does not exist registered to an individual, and thus registering the share of an asset whose owner cannot be identified or whose ownership does not exist so that the ownership of the share can be recognized from the public.

Therefore, it would be obvious that the technical features of the present inventive concept cannot be inferred through the above prior art, wherein the technical feature of the present inventive concept is registering the share of owner unspecified or owner non-existent asset in which the owner cannot be specified or does not exist to an individual.

In addition, Korean Patent No. 2002644 (2019 Jul. 16) relates to a method of providing an up-price transaction service using a numeric URL-based O2O platform, is characterized in that when receiving an offline store registration request and an O2O (Online To Offline) platform apply from a user terminal, an online shopping mall having a numeric domain assigned from a numeric URL to a user terminal is sold, the numeric domain and offline store identifiers with a user terminal are mapped and stored, the up-price market price of the online shopping mall in real time is updated based on the number of members, products, sales, and the number of affiliated stores of the online shopping mall sold to the user terminal, a floating value data corresponding to the up-price of the user terminal in the fixed value data of the offline store is registered, and a registration right is issued to the user terminal.

The prior art is to issue a registration right registered according to the market price of an online shopping mall, and thus there is a clear distinction between the prior art and the present inventive concept, which registers the share of the asset using blockchain technology in order to register the share of the owner unspecified asset that the owner cannot be specified or the ownership does not exist to an individual, and thereby allowing the public to recognize the ownership of the share.

### DISCLOSURE

### Technical Problem

The present inventive concept was devised to solve the above problems, and it is an objective to provide a system and method for registering a share for an owner unspecified asset in which an owner cannot be specified or does not exist in the public domain using a blockchain.

It is another objective for the present inventive concept to split an owner unspecified asset in which an owner cannot be specified or does not exist into a plurality of shares, generate a lot number by allocating an identifier for each of the split shares, generate a register comprising the split share and the lot number, register the ownership of each of the shares with the prepared register, thereby allowing the public to recognize the public confidence in the ownership to each of the individuals.

It is another objective for the present inventive concept to split the asset into a plurality of equally sized split shares, subdivide the shares by splitting each of the plurality of equally sized split shares into smaller units of shares, allocate a unique identifier to each of the shares, add a personal identifier directly assigned by an individual who has registered for the share to the unique identifier, and thereby registering each of the shares for the asset.

It is another objective for the present inventive concept to provide a public registration for the share of the owner unspecified asset, wherein it is impossible to cancel the registration based on a blockchain distributed and stored in at least one or more blockchain nodes, and the registration result is connected to other registrations and used for a cause for a new registration.

It is another objective for the present inventive concept to provide public registration for the share of the owner unspecified assets, including a planet of the moon or Mars for which no owner can be specified, or no ownership exists, or the Earth's South Pole, Arctic, deep sea, or out sea for which no owner can be specified, or no ownership exists.

### Technical Solution

A blockchain-based public registration system for a share of an asset, of which owner cannot be specified or ownership does not exist, according to an embodiment of the present inventive concept, is characterized in comprising a blockchain node with a processor configured to comprise: splitting the asset of which owner cannot be specified or ownership does not exist, into a plurality of equal sized shares, and storing each of the shares in a database; creating a lot number by allocating a unique identifier to each of the plurality of split shares, and storing the created lot number in the database; and composing a register comprising the share and the lot number, storing the composed register in a blockchain, and thus registering an ownership-on-the-blockchain for the share for an individual participating in the blockchain, wherein the asset is the one of which owner cannot be specified or ownership does not exist, the share, the lot number, and the register are respectively a share-on-the-blockchain, a lot-number-on-the-blockchain, and a register-on-the-blockchain, and wherein the ownership-on-the-blockchain is granted by the blockchain to the individual participating in the blockchain.

Wherein, it is characterized in that each of the plurality of split shares can be subdivided into smaller units of shares, respectively, and the lot number is configured by adding a personal identifier assigned directly by the individual to the unique identifier.

It is characterized in that the blockchain-based public registration system is configured to comprise: enabling a plurality of right holders who have previously registered the ownership-on-the-blockchain through registrations stored in the blockchain for the plurality of split shares to recognize public confidence for the ownership-on-the-blockchain to the individual participating in the blockchain, wherein the recognizing of the public confidence is granted by the plurality of right holders who have already registered the ownership-on-the blockchains for the shares in the blockchain. Since the next right holder cannot register the share in case that any previous right holder does not allow the registration to the next right holder, if the contractual conditions specified in the register for the corresponding share are satisfied, all previous right holders need to sign a contract to allow the registration unconditionally.

It is characterized in that the registering of the ownership-on-the-blockchain is configured to comprise: composing the register specifying the share that the individual wants to purchase and the lot number with the identifier assigned to the individual, by matching the share with the lot number, in case that the individual participating in the blockchain purchases the share and wants to register the ownership-on-the-blockchain; endorsing a registration by requesting an endorsement of the registration by transmitting the composed register to at least one or more other blockchain nodes; confirming the registration after receiving the register endorsed by the at least one or more other blockchain nodes; and executing the registration by registering the ownership-on-the-blockchain to the individual for the purchased share, by creating the confirmed register as a block, connecting the created block to the block in which the previously registered share is recorded with a chain, and distributing and storing the connected block (i.e., blockchain) in the at least one or more blockchain nodes.

Wherein, it is characterized in that the registration based on the blockchain distributed and stored in the at least one or more blockchain nodes cannot be cancelled, and a result of the registration is connected to other registrations and can be utilized as a cause for a new registration.

Wherein, it is characterized in that the asset comprises: a planet for which no owner can be specified or no ownership exists, comprising the moon or Mars; or an area for which owner cannot be specified or ownership does not exist, comprising Antarctic, Arctic, deep sea, or out sea of the Earth.

On the other hand, it is characterized in that a blockchain-based public registration method for a share of an asset, of which owner cannot be specified or ownership does not exist, according to an embodiment of the present inventive concept, comprises: in a blockchain-based public registration system for the share of the asset of which owner cannot be specified or ownership does not exist, selecting a share of a plurality of shares split by an equal size for the asset in which owner cannot be specified or ownership does not exist; in the blockchain-based public registration system, selecting a lot number assigning a unique identifier to the selected share; and in the blockchain-based public registration system, composing a register comprising the selected share and the selected lot number, and storing the composed register in a blockchain, so that an ownership-on-the-blockchain be registered for the share to an individual participating in the blockchain, wherein the asset is the one of which owner cannot be specified or ownership does not exist, the share, the lot number, and the register are respectively a share-on-the-blockchain, a lot-number-on-the-blockchain, and a register-on-the-blockchain, and wherein the ownership-on-the-blockchain is granted by the blockchain to the individual participating in the blockchain.

Wherein, it is characterized in that each of the plurality of shares can be subdivided into smaller units of shares, respectively, and the lot number is configured by adding a personal identifier assigned directly by the individual to the unique identifier.

It is characterized in that the method further comprises: in the blockchain-based public registration system, composing the register specifying the share that the individual wants to purchase and the lot number with the identifier assigned to the individual, by matching the share with the lot number, in case that the individual participating in the blockchain purchases the share and wants to register the ownership-on-the-blockchain; in the blockchain-based public registration system, endorsing a registration by requesting an endorsement of the registration by transmitting the composed register to at least one or more other blockchain nodes; in the blockchain-based public registration system, confirming the registration after receiving the register endorsed by the at least one or more other blockchain nodes; and in the blockchain-based public registration system, executing the registration by registering the ownership-on-the-blockchain to the individual for the purchased share, by creating the confirmed register as a block, connecting the created block to the block in which the previously registered share is recorded with a chain, and distributing and storing the connected block (i.e., blockchain) in the at least one or more blockchain nodes.

It characterized in that the registration based on the blockchain distributed and stored in the at least one or more blockchain nodes cannot be cancelled, and a result of the registration is connected to other registrations and can be utilized as a cause for a new registration.

Wherein, it is characterized in that the asset comprises: a planet of which no owner can be specified or no ownership exists, comprising the moon or Mars; or an area of which owner cannot be specified or ownership does not exist, comprising Antarctic, Arctic, deep sea, or out sea of the Earth.

### Advantageous Effects

As described above, it is effective for the registration system and method for a share of an asset in which the owner cannot be specified or the ownership does not exist, in accordance with the present inventive concept, to register an owner non-specific asset whose owner cannot be specified or ownership does not exist, fairly through the public participation by a trust system based on a blockchain, so that the ownership can be objectively recognized by the public.

### BRIEF DESCRIPTION OF DRAWINGS

FIG. 1 shows a logical conceptual diagram of a blockchain-based public registration system for a share of an asset, of which owner cannot be specified or ownership does not exist, according to an embodiment of the present inventive concept.

FIG. 2 shows a view for explaining a flow of a blockchain-based public registration process for a share of a common asset, of which owner cannot be specified or ownership does not exist, in a blockchain node according to an embodiment of the present inventive concept.

FIG. 3 shows a diagram illustrating a procedure for performing blockchain-based public registration for a share of a common asset, of which owner cannot be specified or ownership does not exist, in a blockchain network according to an embodiment of the present inventive concept.

FIG. 4 shows a block diagram illustrating a structure of a blockchain node in the public registration system for a share of an asset, of which owner cannot be specified or ownership does not exist, according to an embodiment of the present inventive concept.

FIG. 5 shows a flowchart illustrating a procedure for registering a share of an asset, of which owner cannot be specified or ownership does not exist, according to an embodiment of the present inventive concept.

FIG. 6 shows a flowchart illustrating a blockchain-based ownership transfer registration procedure for a share of an asset, of which owner cannot be specified or ownership does not exist, according to an embodiment of the present inventive concept.

FIG. 7 shows a diagram illustrating the hardware architecture of a blockchain node in the public registration system for a share of an asset, in which owner cannot be specified or ownership does not exist, according to an embodiment of the present inventive concept.

### DETAILED DESCRIPTION

Hereinafter, preferred embodiments of a system and method for registering a share for an asset in which an owner cannot be specified or an ownership does not exist of the present inventive concept are described in detail with reference to the accompanying drawings. The same reference numerals indicate the same elements in each drawing. In addition, specific structural or functional descriptions for the embodiments of the present inventive concept are only exemplified for the purpose of describing the embodiments according to the present inventive concept, unless defined otherwise, all terms used herein, including technical or scientific terms, have the same meaning as commonly understood by one of ordinary skill in the art to which the present inventive concept belongs. Terms such as those defined in a commonly used dictionary should be interpreted as having a meaning consistent with the meaning in the context of the related art, unless defined herein the present specification, it is desirable not to be interpreted in an idealistic or overly formal sense.

Hereinafter, an overall blockchain network configuration for public registration for a share of an owner-non-specific asset where the owner cannot be specified or ownership does not exist is explained.

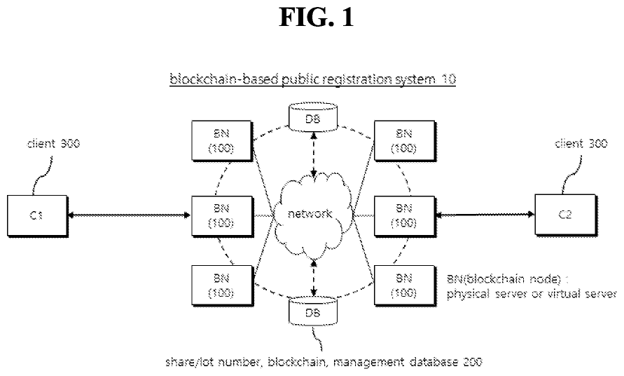

FIG. 1 shows a logical conceptual diagram of a blockchain-based public registration system for a share of an asset, of which owner cannot be specified or ownership does not exist, according to an embodiment of the present inventive concept.

As shown in FIG. 1, a blockchain-based public registration system 10 for a share of an owner-unspecified asset according to an embodiment of the present inventive concept comprises a plurality of blockchain nodes 100 forming a blockchain, a client 300 connected to each of a plurality of blockchain nodes 100, and a database 200 connected to each of a plurality of blockchain nodes 100. Wherein, the database 200 comprises a share/lot number database 200a for storing information related to the share/lot number, a blockchain database 200b for storing information related to the blockchain, and a management database 200c for storing management information related to a registrant, authentication, account, electronic wallet, applications and the like.

Each of the plurality of blockchain nodes 100 is configured to play roles of a blockchain node 100 and a public registration platform at the same time, in the blockchain-based public registration system 10 for the share of the owner-unspecified assets according to an embodiment of the present inventive concept. In addition, each of the plurality of blockchain nodes 100 may be configured as a physically independent system or may be configured as a virtual node. That is, one physically existing server may be divided into two and then virtualized and then configured as two blockchain nodes 100. However, the virtualized blockchain node 100 must also be able to designate the location of the corresponding blockchain node in the same way as designating the location of the physically independent server with an independent IP address.

The blockchain node 100 preferably performs the functions necessary for generating a register and blocks at the same time, and therefore a user interface necessary for public registration for the share of an owner-unspecified asset is provided to the client through the web server.

The client 300 is a program installed in a customer terminal so that a customer (or a user) comprising a registrant, an owner, a person wishing to register, an administrator, etc. can access the blockchain node 100. The customer connects to the blockchain node 100 on a web basis generates a register for the share he/she wants, requests the registration to the blockchain node 100, and makes the result of the registration delivered, when the blockchain node 100 connects to the blockchain and completes the registration.

The customer who wants to publicly register the share of the owner-unspecified asset pays a predetermined amount of money and makes a contract with the blockchain node 100, and when the contract is made, the blockchain node 100 registers the share for the customer in the blockchain and provides the registration result to the customer. In the present inventive concept, in principle, the parties to a trade are not defined as specific persons, but when a predetermined transaction amount is paid in the blockchain node 100, a register is created for a pre-specified share, recorded on the blockchain and then the result of the registration is notified to corresponding customer. However, since there is a case where a registrant as a customer purchases a share, registers the share, and then transfers the corresponding share to another person, in this case, the parties, the buyer and seller, involved in the trade are specified, certified for the corresponding trade from the public, and transfer the ownership and the registration.

Each blockchain node 100 plays a role of a platform managing membership, account, authentication (password), etc. of customers accessing the blockchain, and through which the customers manage their e-wallets and credits. The present inventive concept allows each blockchain node 100 to perform the manager function for the public registration system 100 for the share of the owner-unspecified asset, so that the managing results can be shared by multiple blockchain nodes in real time.

When a client 300 connects to each blockchain node 100 and performs actions necessary for registration, it is possible for each corresponding customer according to the client to receive services such as membership, authentication, account management, electronic wallet charging, etc.

The plurality of blockchain nodes 100 are interconnected to each other through a network, the plurality of blockchain nodes 100 and the clients can be interconnected through the Internet or intranet, so that customers including administrators of blockchain nodes can access the plurality of blockchain nodes 100. In addition, even the present inventive concept does not have a very large number of physical blockchain nodes 100, it has a structure that does not require excessive expansion of infrastructure for blockchain nodes, such as connecting more than a certain number of physical servers, by creating multiple virtual blockchain nodes within one physical blockchain node and permanently managing the multiple virtual blockchain nodes.

In the present inventive concept, the asset to be registered refers to a common asset whose owner cannot be specified, the common asset comprises planets including the Moon or the Mars, or an area in which no owner can be specified or ownership does not exist, including the Earth's Antarctic, Arctic, deep sea or out sea.

Hereinafter, the process of public registration for the share of the owner-non-specific asset in the blockchain node is explained.

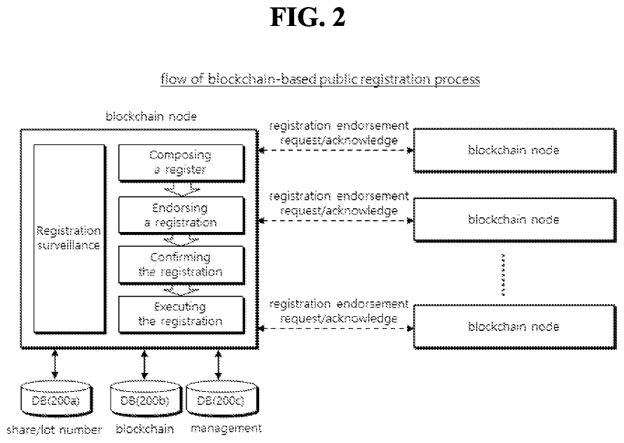

FIG. 2 shows a view for explaining a flow of a blockchain-based public registration process for a share of a common asset, of which owner cannot be specified or ownership does not exist, in a blockchain node according to an embodiment of the present inventive concept.

As shown in FIG. 2, the blockchain node 100 according to an embodiment of the present inventive concept is configured to comprise performing at least one or more functions of composing a register, endorsing a registration, confirming the registration, executing a registration, surveilling the registration, or a combination thereof. Among these functions, the function such as surveilling the registration monitors whether there are any violations of conditions when performing functions such as composing the register, endorsing the register, confirming the register, executing the registration, and the like. Therefore, not all blockchain nodes 100 can perform the registration only if they have the function of surveilling the registration. However, the surveilling of the registration is configured to provide the corresponding register to the customer when someone wants to browse the registration after the registration is completed.

In addition, not all blockchain nodes 100 must comprise the functions of composing the register, endorsing the register, confirming the registration, and executing the registration. However, if all functions of composing the register, endorsing the registration, confirming the registration, and executing the registration are comprised in a blockchain node 100, the blockchain node 100 plays a role of a registration platform. And a specific blockchain node 100 may be configured to perform only minimum functions for performing the role of the blockchain node. If a blockchain node does not create a new registration, but only endorses the register with the blockchain, it is also possible to configure a blockchain node only to perform endorsing a registration.

In more detail, the composing of a register means that a registrant (i.e., a person who has a right to register the share) searches for registration conditions in a client, agrees on the registration conditions, and composes a register. Once a user has chosen a location and identifier for a particular share and paid for the share, the user completes a ready to enter into a contract, in this process, the registrant (i.e., a person who has a right to register) designates the location of the share and the lot number which is an identifier according to the location, makes a contract for a registration, composes a register, and then performs the registration according to the contract (i.e., a registration contract).

Since the registration contract can be carried out with the registrant (i.e., a person who has a right to register the share) agreeing to the registration conditions, the registration condition in the blockchain node according to the present inventive concept is once established by the registrant confirming and signing the registration conditions. Here, the registration conditions for the registration contract are recorded through scripts, data structures, programs, metadata, etc. Therefore, the composing of a register is a process in which a registrant prepares a registration contract for the registration.

According to the set registration conditions (i.e., the register composition), the client creates a register and then transmits the created register to the blockchain node, and the blockchain node requests an endorsement of the register to other blockchain nodes. The blockchain nodes participating in the endorsement of the registration examine whether the registration conditions violate the principle of public registration through the blockchain set in advance in the principle and deliver the result to the blockchain node that requested the endorsement of the registration.

In addition, the endorsement of the registration is performed according to a registration endorsement policy, the registration endorsing policy is made using the signature of a blockchain node with a registration endorsing function, the blockchain node designates a set of other nodes participating in the endorsement of the registration and should receive appropriate signatures for the same content from all corresponding set of blockchain nodes. The blockchain node should receive appropriate signature from blockchain nodes with an arbitrary registration function affiliated to the set.

If no problem is found by checking the results for the registration endorsement received from other blockchain nodes, the confirming of the registration is performed.

The executing of the registration is to execute the process of agreement on the registration with the blockchain, wherein the agreement is performed by the blockchain nodes participating in the registration through voting the order for the registration posted from multiple clients. The result of the agreement is transmitted to all nodes maintaining the blockchain. There might be a blockchain node that does not participate in executing of the registration, but confirms the registration and maintains the blockchain, and thus the blockchain node that has confirmed the registration verifies the registration results executed by the nodes with the endorsement of the registration, and updates the registration result if there is no problem in the verification.

Through this process, a plurality of registrations can be executed at the same time.

The executing of the registration is configured to comprise a role of distributed storing the result of the execution of the registration contract in the blockchain nodes with the blockchain. In the block, the data related to the parties to the registration contract and the contents of the registration contract are recorded. The recorded data contents become the basic data of the trade. The executing of the registration is configured to comprise forming a blockchain by independently distributing the block data to each group that groups the contracting parties comprising a new right holder of the registration and a previous right holder of the registration and storing the block data in a blockchain network composed of a plurality of blockchain nodes.

The surveilling of the registration is configured to monitor the registration result and registration time at each stage of setting of the registration, endorsement of the registration, and executing of the registration for the registration contract being processed by the registration endorsing unit and the registration execution unit and output the results. Just as a registration contract is make between specific registration parties, a registration contract in a blockchain network can also be formed only between specific blockchain nodes participating in the registration contract. However, all nodes form a blockchain with the result of the registration contract and share and store the blockchain. Since the next right holder cannot register the share in case that any previous right holder does not allow the registration to the next right holder, if the contractual conditions specified in the register for the corresponding share are satisfied, all previous right holders need to sign a contract to allow the registration unconditionally.

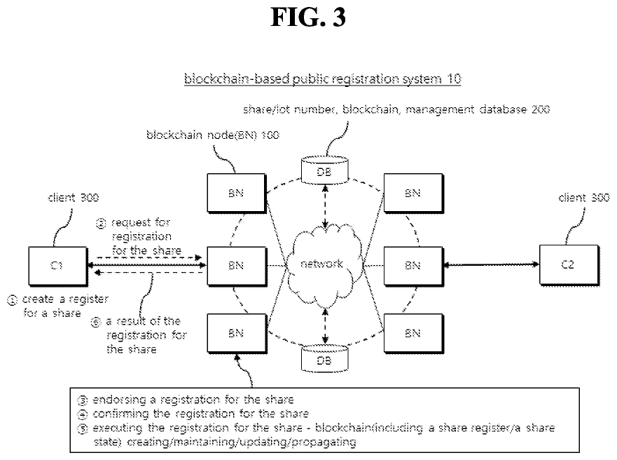

FIG. 3 shows a diagram illustrating a procedure for performing blockchain-based public registration for a share of a common asset, of which owner cannot be specified or ownership does not exist, in a blockchain network according to an embodiment of the present inventive concept.

As shown in FIG. 3, the client 300 connects to the blockchain node 100 of the present inventive concept through the web-basis, creates a register for the share (\textcircled{1}), requests a registration of the share to the blockchain node 100 (\textcircled{2}), then the blockchain node 100 connected to the client requests an endorsement of the registration for the share to at least one predetermined blockchain nodes (\textcircled{3}), and thus the blockchain nodes 100 participating in the endorsement of the registration for the share provide a response for the endorsement of the registration. Next, the blockchain node receives the requested endorsement of the registration for the share, and if there is no problem, confirms the registration (\textcircled{4}), then the registration for the share is executed by creating a block for the registration of the corresponding share, forming a blockchain with the created block, and then recording the formed blockchain in other blockchain nodes (\textcircled{5}). Finally, the result of the registration for the share is delivered to the client (\textcircled{6}).

In a blockchain node, the order of registrations for the shares posted from each of multiple clients is agreed upon by participating blockchain nodes through voting, and the agreement result is transmitted to all nodes maintaining the blockchain. There may be blockchain nodes that do not participate in the execution of the registration for the share but maintain the blockchain and confirm the registration for the share, and the blockchain nodes that have confirmed the registration for the share verify the registration result for the share executed by the nodes with the registration endorsement for the share and update the registration result for the share if there is no problem. Through this process, a plurality of registrations for the shares can be executed at the same time.

By configuring the function of surveilling of the registration for a share, which monitors the processes of composing of the register for the share, endorsing of a registration, confirming of the registration, and executing the registration, in the blockchain node, it is possible to provide the results of how each registration of the share is progressing to the clients participating in the registration of the share.

The client may take actions to destroy the corresponding registration of the share, if the corresponding registration of the share does not proceed according to the predetermined conditions, and this may be set as a condition for a registration for a share.

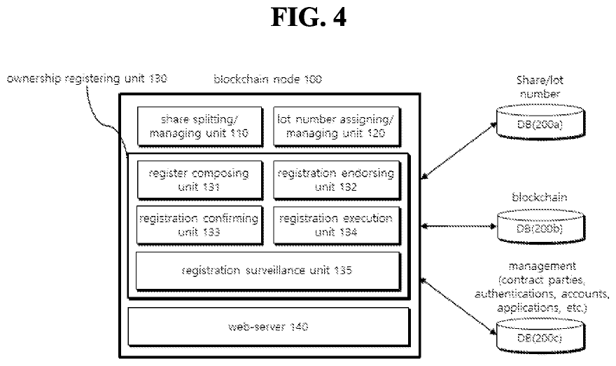

FIG. 4 shows a block diagram illustrating a structure of a blockchain node in the public registration system for a share of an asset, of which owner cannot be specified or ownership does not exist, according to an embodiment of the present inventive concept.

As shown in FIG. 4, the blockchain node 100 according to the present inventive concept is configured to comprise a share splitting/managing unit 110, a lot number assigning/managing unit 120, an ownership registering unit 130, and a web server 140.

The share splitting/managing unit 110 is configured to play roles of managing a plurality of shares which is split from an asset in which an owner cannot be specified, or an ownership does not exist, especially play roles of retrieving the information for the no-ownership-assigned-share from the share database 400 and providing the information to the customer, or retrieving the information of what the ownership of a specific share is registered and recorded in the blockchain e from the blockchain database 500 and providing the information to the customer.

The asset for which the owner cannot be specified, or the ownership does not exist is split into the plurality of equally sized shares, and each of the plurality of shares may be further split into smaller units of shares. That is, the share can be further subdivided by splitting the share.

After all, the share splitting/managing unit 110 is configured to comprise managing a plurality of shares by splitting an asset that cannot specify the owner or does not have ownership into the plurality of shares, splitting the asset into the plurality of equally sized shares, and subdividing each of the plurality of shares into smaller units of shares.

The lot number assigning/managing unit 120 is configured to comprise generating and managing a lot number by allocating an identifier to the split and stored specific share. The lot number assigning/managing unit 120 is configured to comprise allocating a unique identifier to each of the plurality of shares and adding a personal identifier directly assigned by the individual who will register the share to the unique identifier.

The identifier is stored in the identifier database 400, and the identifier is divided into a registered identifier and an unregistered identifier. The registered identifier refers to the address of a share that has already been registered and sold, and the unregistered identifier refers to the address of a share that has not yet been registered. In addition, since the identifier for the share is completed using the number that the customer finally allocates, a unique number allocated to each share of a plurality of split shares is stored in the identifier database 400.

In the end, the lot number assigning/managing unit 120 is configured to comprise managing the lot number by allocating an identifier to the split share, allocating a unique identifier to each of the plurality of shares, and adding a personal identifier directly assigned by the individual who will register the share to the unique identifier.

The ownership registering unit 130 is configured to comprise a register composing unit 131, a registration endorsing unit 132, a registration confirmation unit 133, a registration executing unit 134, and a registration surveillance unit 135.

The ownership registering unit 130 is configured to play a role to complete the registration by recording the register for the corresponding share in the blockchain when the customer requests the registration for a specific share as a registration right holder. The ownership registering unit 130 executes the process of trading a specific share for an asset that cannot specify the owner or does not have ownership, and then registering the corresponding share in a blockchain, as a single contract.

The customer who wants the registration can make a contract for acquiring assets at a predetermined time according to specific registration conditions, and the timing of the registration according to the acquisition of assets may be adjusted by the request of the customer. Also, once a contract for a registration is made, a previous contract cannot be canceled unless the contract is a new renewal contract. The result of the registration is connected to other existing registrations and becomes a causal act for a new registration. That is, by generating a trade between a registration and another registration, it is possible to integrate a plurality of registrations to bind into a single registration. This concept provides fairness and public confidence in the registration for a share of an asset for which the owner cannot be specified or the ownership does not exist.

The register composing unit 131 is configured to play a role of composing a corresponding register by a registration right holder searching for registration conditions and agreeing on the registration conditions in the client. Once a person has chosen a location and identifier for a particular share and paid for the share, he/she is completely ready to enter a contract. In this process, the registration right holder designates a location of a share and a lot number which is an identifier according to the location, and then signs a contract for registration, composes the register and endorses the register, then the registration contract is made.

Since the registration contract can be carried out with the registration right holder agreeing on the registration conditions, the registration conditions are once established in the blockchain node according to the present inventive concept by the registration right person confirming and signing the registration conditions. Here, the registration contract conditions for the registration are recorded through scripts, data structures, programs, metadata, etc. Therefore, the composing of the register is the process in which the registration right holder prepares a registration contract for a registration.

According to the set registration conditions (composition), the client creates a register, and then delivers the created register to the blockchain node, the blockchain node requests a registration endorsement to other blockchain nodes. The blockchain nodes participating in the registration endorsement, review whether the registration conditions violate the principle of public registration set in advance in the principle through the blockchain and delivers the result to the blockchain node that requested the registration endorsement.

In addition, the registration endorsing unit 132 is configured to perform a registration endorsement according to the registration endorsing policy, which is prepared using the signature of the blockchain node with the registration endorsing function, designate the set of other nodes participating in the endorsement, and receive appropriate signatures having the same content from all the corresponding set of blockchain nodes.

The registration confirming unit 133 is configured to confirm the registration, if no problem is found in the registration in the results of the registration endorsement received from other blockchain nodes.

The registration execution unit 134 is configured to execute the process of agreeing on the registration with the blockchain, and thus blockchain nodes participating in the registration agree on the order for the registrations posted from multiple clients through voting. The agreement result is transmitted to all nodes maintaining the blockchain. There might be a blockchain node that does not participate in the registration execution, but maintains the blockchain and performs the registration confirmation, the blockchain node that has confirmed the registration verifies the registration results executed by the nodes with the registration endorsement and updates the registration result if there is no problem. Through this process, a plurality of registrations can be executed at the same time.

The registration execution unit 134 is configured to comprise a role of distributing and storing the execution result of the registration contract in the blockchain nodes with the blockchain. In a block, the data related to the parties to the registration contract and the contents of the registration contract are recorded. The recorded contents become the basic data of a trade, and independently distributed for each group that groups the contracting parties including the person with the right to register and the person with the right to be registered and stored in a blockchain network composed of a plurality of blockchain nodes, and thus forming a blockchain.

The registration surveillance unit 135 is configured to monitor the registration result and registration time from time to time at each stage of registration setting, registration endorsement, and registration execution for the registration contract being processed in the registration endorsing unit 132 and the registration execution unit 134 and provide the results. Just as a registration contract is made between specific registration parties, a blockchain network can also be formed only between specific blockchain nodes participating in the registration contract. However, all nodes form a blockchain with the results, and share and store the corresponding blockchain.

The web server 140 is configured to provide a web-based service when a client device tries to access a blockchain node 100 according to the present inventive concept from a client device. In this case, the client device remotely accesses the blockchain node 100 and requests a registration contract, receive a notification for the registration results, and in addition, the registration status for each share can be searched through the blockchain.

The web server 140 is configured to play roles of storing membership, authentication, and account of the customer who accesses the blockchain according to the present inventive concept in the management database 600, and managing them, and thus the blockchain node plays a role of a platform through which the customer manages his e-wallet or credit. The customer may be provided with services such as membership, authentication, account management, and electronic wallet charging through the web server 160. To this end, the web server 140 provides a link to the cryptocurrency of the customer as well as a bank account or credit card, and enables the customer issue and handle coupons, cash, jewelry, and the like.

The platform according to the present inventive concept ensures anonymity in the registration of shares between stakeholders by restricting unauthorized parties to access to some information, and by limiting the basic requirement of a blockchain platform that an unauthorized party must inspect the blockchain ledger to verify the identity and transaction patterns of all parties in the network.

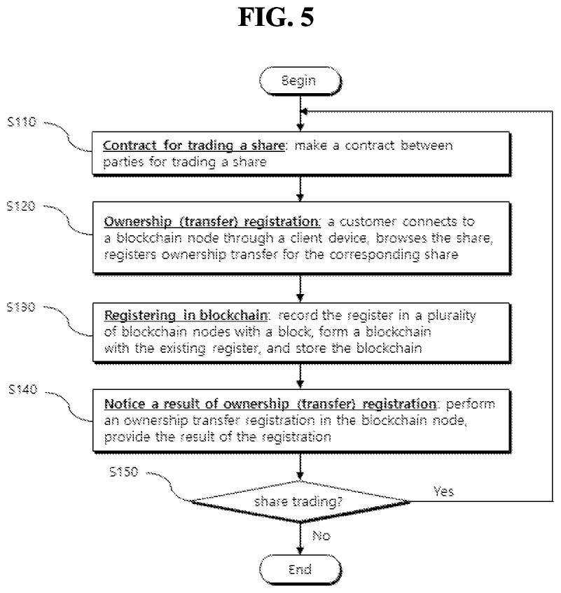

FIG. 5 shows a flowchart illustrating a procedure for registering a share of an asset, of which owner cannot be specified or ownership does not exist, according to an embodiment of the present inventive concept.

As shown in FIG. 5, the client 300 first connects to the blockchain node 100 through a web server, and then makes a share trading contract (S110). In other words, a share trading contract is first made between the share trading parties for the share of a specific asset.

Then, an ownership (transfer) registration is performed according to the share trading contract (S120). The client 300 creates a register for a registration contract, request a registration endorsement by submitting the register to arbitrary nodes. Here, the process of creating a register and submitting the registration is that the client connects to the blockchain node through the web server, then sets the conditions for registration necessary for the registration contract, then creates the register, so that the client requests the execution of the registration contract to the blockchain node.

The blockchain node delivers the registration endorsement to at least one or more predetermined blockchain nodes according to the registration endorsement request, and the blockchain nodes participating in the registration endorsement execute the registration through the registration execution unit 134, and then, transmit a message indicating that a registration is endorsed to the client as the result of the registration execution. Here, the registration endorsement is created using the signature of the blockchain node with the registration endorsing function, and the registration is endorsed by designating the set of other blockchain nodes participating in the registration endorsement and receiving a suitable signature with the same content from all the corresponding set of other blockchain nodes.

Next, blockchain registration is performed (S130). That is, the registration execution unit 134 is configured to execute an agreement process on the registration with the blockchain. Blockchain nodes participating in the registration execution agree on the order of registrations posted from multiple clients through voting. Then agreement result is transmitted to all nodes maintaining the blockchain. That is, the blockchain node confirms the registration for maintaining the blockchain.

The blockchain node that has confirmed the registration verifies the registration result executed by the nodes that have endorsed the registration, and if there is no problem, updates and propagates the registration result. Through this process, a plurality of registrations can be executed at the same time.

If there is a trade of the share after the registration of the share for an asset for which a specific owner cannot be specified or the ownership does not exist is completed, the parties for the trade of the share make a contract for the trade of the share, and updates the registration and records the updated registration in the blockchain, then notifies the result of the renewal registration to each of the parties (S140).

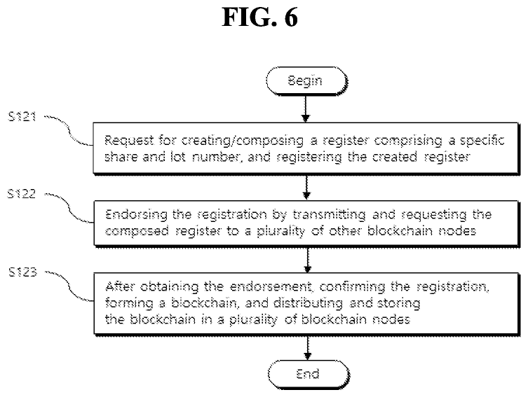

FIG. 6 shows a flowchart illustrating a blockchain-based ownership transfer registration procedure for a share of an asset, of which owner cannot be specified or ownership does not exist, according to an embodiment of the present inventive concept.

As shown in FIG. 6, the procedure for performing the blockchain-based ownership transfer registration for the share of an asset in which the owner cannot be specified or the ownership does not exist according to an embodiment of the present inventive concept is explained.

First, a register comprising a specific share and lot number to be registered is created, and the registration is requested to the blockchain node (S121). Then, the requested registrar is transmitted to a plurality of other blockchain nodes to authenticate the register (S122). The blockchain node 100 confirms the registration after receiving the authentication, and the public registration of the share is performed by storing the registration in a distributed manner with a form of a blockchain in a plurality of blockchain nodes (S123).

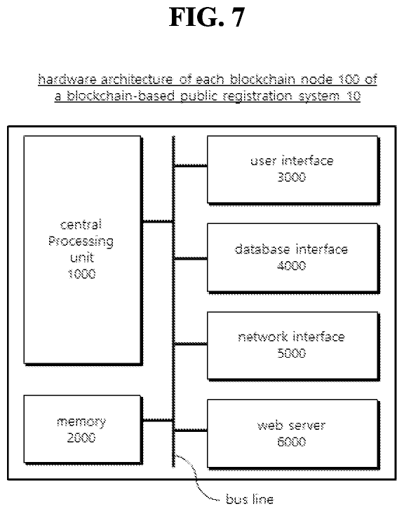

FIG. 7 shows a diagram illustrating the hardware architecture of a blockchain node in the public registration system for a share of an asset, in which owner cannot be specified or ownership does not exist, according to an embodiment of the present inventive concept.

As shown in FIG. 7, the hardware architecture of the blockchain node 100 in the blockchain-based public registration system 10 for the share of the common asset is configured to comprise a central processing unit (i.e., a processor) 1000, a memory 2000, a user interface 3000, and a database interface 4000, a network interface 5000, a web server 6000, and the like.

The user interface 3000 is configured to provide input and output interfaces to a user by using a graphical user interface (GUI).

The database interface 4000 is configured to provide an interface between a database and the hardware of the blockchain node. The network interface 5000 is configured to provide a network connection between devices owned by a user.

The web server 6000 is configured to provide a tool for a user to access the hardware of the blockchain node via a network. Most users can remotely access the web server (i.e., web-based access) and use the public registration system 10 through the blockchain node 100.

The above-described configuration or each step of method may be implemented as computer-readable code on a computer-readable recording medium or transmitted through a transmission medium. The computer-readable recording medium is a data storage device capable of storing data that can be read by a computer system.

Examples of computer-readable recording media include, but are not limited to, databases, ROMs, RAMs, CD-ROMs, DVDs, magnetic tapes, floppy disks, and optical data storage devices. The transmission medium may include a carrier transmitted through the Internet or various types of communication channels. In addition, the computer readable recording medium may be distributed through a network coupled computer system so that the computer readable code is stored and executed in a distributed manner.

In addition, at least one or more components applied to the present inventive concept may include or be implemented by a processor such as a central processing unit (CPU), a microprocessor, etc. that perform each function of the components, and two or more of the components may be combined into a single component to perform all operations or functions for the combined two or more components. In addition, a part of at least one or more components applied to the present inventive concept may be performed by other components among these components. In addition, communication between the components may be performed through a bus.

In the above description, while preferred embodiments according to the present inventive concept have been mainly described above. The present inventive concept is not limited thereto, and each component of the present inventive concept may be changed or modified within the technical scope of the present inventive concept to achieve the same purpose and effect. In addition, although preferred embodiments of the present inventive concept have been illustrated and described above, the present inventive concept is not limited to the specific embodiments described above, and of course various modifications can be made by those of ordinary skill in the art to which the present inventive concept pertains without departing from the essential points of the invention as claimed in the claims, and these variant implementations should not be understood separately from the technical idea or prospect of the present inventive concept.

The registration system and method for a share of an asset for which owner cannot be specified or ownership does not exist are configured to make the ownership objectively recognized by the public, by registering the share with the public participates by a trust system based on the blockchain for the share of a public asset, which is an owner non-specific asset whose owner cannot be specified or ownership does not exist.

What is claimed is:

1. A blockchain-based public registration system for a share of an asset of which owner cannot be specified or ownership does not exist, comprising a blockchain node with a processor configured to comprise:
splitting the asset of which owner cannot be specified or ownership does not exist, into a plurality of equal sized shares, and storing each of the shares in a database;
creating a lot number by allocating a unique identifier to each of the plurality of split shares, and storing the created lot number in the database; and
composing a register comprising the share and the lot number, storing the composed register in a blockchain, and thus registering an ownership-on-the-blockchain for the share for an individual participating in the blockchain,
wherein the asset is the one of which owner cannot be specified or ownership does not exist, the share, the lot number, and the register are respectively a share-on-the-blockchain, a lot-number-on-the-blockchain, and a register-on-the-blockchain, and
wherein the ownership-on-the-blockchain is granted by the blockchain to the individual participating in the blockchain.

2. The system of claim 1, wherein each of the plurality of shares can be subdivided into smaller units of shares, respectively, and the lot number is configured by adding a personal identifier assigned directly by the individual to the unique identifier.

3. The system of claim 1, wherein the processor is further configured to comprise:
enabling a plurality of right holders who have previously registered the ownership-on-the-blockchain through registrations stored in the blockchain for the plurality of shares in which the asset has been split to recognize public confidence for the ownership-on-the-blockchain to the individual participating in the blockchain,
wherein the recognizing of the public confidence is granted by the plurality of right holders who have already registered the ownership-on-the blockchains for the shares in the blockchain.

4. The system of claim 1, wherein the processor is further configured to comprise:
composing the register specifying the share that the individual wants to purchase and the lot number with the identifier assigned to the individual, by matching the share with the lot number, in case that the individual participating in the blockchain purchases the share and wants to register the ownership-on-the-blockchain;
endorsing a registration by requesting an endorsement of the registration by transmitting the composed register to at least one or more other blockchain nodes;
confirming the registration after receiving the register endorsed by the at least one or more other blockchain nodes; and
executing the registration by registering the ownership-on-the-blockchain to the individual for the purchased share, by creating the confirmed register as a block, connecting the created block to the block in which the previously registered share is recorded with a chain, and distributing and storing the connected block (i.e., blockchain) in the at least one or more blockchain nodes.

5. The system of claim 4, wherein the registration based on the blockchain distributed and stored in the at least one or more blockchain nodes cannot be cancelled, and a result of the registration is connected to other registrations and can be utilized as a cause for a new registration.

6. The system of claim 1, wherein the asset comprises:
a planet for which no owner can be specified or no ownership exists, comprising the moon or Mars; or
an area for which owner cannot be specified or ownership does not exist, comprising Antarctic, Arctic, deep sea, or out sea of the Earth.

7. A blockchain-based public registration method for a share of an asset, of which owner cannot be specified or ownership does not exist, comprising:
in a blockchain-based public registration system for the share of the asset of which owner cannot be specified or ownership does not exist, selecting a share of a plurality of shares split by an equal size for the asset in which owner cannot be specified or ownership does not exist;
in the blockchain-based public registration system, selecting a lot number assigning a unique identifier to the selected share; and
in the blockchain-based public registration system, composing a register comprising the selected share and the selected lot number, and storing the composed register in a blockchain, so that an ownership-on-the-blockchain be registered for the share to an individual participating in the blockchain,
wherein the asset is the one of which owner cannot be specified or ownership does not exist, the share, the lot number, and the register are respectively a share-on-the-blockchain, a lot-number-on-the-blockchain, and a register-on-the-blockchain, and
wherein the ownership-on-the-blockchain is granted by the blockchain to the individual participating in the blockchain.

8. The method of claim 7, wherein each of the plurality of shares can be subdivided into smaller units of shares, respectively, and the lot number is configured by adding a personal identifier assigned directly by the individual to the unique identifier.

9. The method of claim 7, wherein the method further comprises:
in the blockchain-based public registration system, composing the register specifying the share that the individual wants to purchase and the lot number with the identifier assigned to the individual, by matching the share with the lot number, in case that the individual participating in the blockchain purchases the share and wants to register the ownership-on-the-blockchain;
in the blockchain-based public registration system, endorsing a registration by requesting an endorsement of the registration by transmitting the composed register to at least one or more other blockchain nodes;
in the blockchain-based public registration system, confirming the registration after receiving the register endorsed by the at least one or more other blockchain nodes; and
in the blockchain-based public registration system, executing the registration by registering the ownership-on-the-blockchain to the individual for the purchased share, by creating the confirmed register as a block, connecting the created block to the block in which the previously registered share is recorded with a chain, and distributing and storing the connected block (i.e., blockchain) in the at least one or more blockchain nodes.

10. The method of claim 9, wherein the registration based on the blockchain distributed and stored in the at least one or more blockchain nodes cannot be cancelled, and a result of the registration is connected to other registrations and can be utilized as a cause for a new registration.

11. The method of claim 7, wherein the asset comprises:
a planet of which no owner can be specified or no ownership exists, comprising the moon or Mars; or
an area of which owner cannot be specified or ownership does not exist, comprising Antarctic, Arctic, deep sea, or out sea of the Earth.
